(19) United States
(12) Patent Application Publication
(10) Pub. No.: US 2019/0333142 A1
(43) Pub. Date: Oct. 31, 2019

(54) SYSTEMS AND METHODS FOR PROCESSING APPLICANT INFORMATION AND ADMINISTERING A MORTGAGE VIA BLOCKCHAIN-BASED SMART CONTRACTS

(71) Applicant: Sarah Apsel THOMAS, San Diego, CA (US)

(72) Inventor: Sarah Apsel THOMAS, San Diego, CA (US)

(21) Appl. No.: 15/965,789

(22) Filed: Apr. 27, 2018

(51) Int. Cl. G06Q 40/02; G06F 17/30; G06Q 50/16; H04L 9/30

(52) U.S. Cl. CPC G06Q 40/025; G06F 17/30283; G06Q 50/167; H04L 2209/38; G06Q 2220/00; H04L 2209/56; H04L 9/30

(57) ABSTRACT

The systems and methods described herein related to a comprehensive blockchain-based tool configured to process applicant information and administer a mortgage via one or more blockchain-based smart contracts. For each applicant, a financial profile may be generated and maintained that includes at least user information and a credit score. Based on the financial profile of an applicant and loan qualification criteria obtained for each of a set of lenders, whether the applicant qualifies for a loan from each lender may be determined. A qualification response may be provided to the applicant indicating each lender from which the applicant may qualify for a loan. The one or more smart contracts may facilitate the loan approval process and administer the loan with minimal input from the lenders themselves. All information and/or documentation obtained may be recorded to the blockchain.

### FIELD OF THE INVENTION

The invention relates to systems and methods for processing applicant information recorded on a blockchain and administering a mortgage via one or more blockchain-based smart contracts.

### BACKGROUND OF THE INVENTION

Conventional approaches to the mortgage loan origination process are frequently quite burdensome to loan applicants. Typically, the process involves obtaining pre-approval from a lender, selecting a property, and then preparing an extensive loan application. Several factors associated with the preparation of a loan application make it difficult or impossible for a loan applicant to simultaneously apply for multiple loans and compare final terms.

Although a loan applicant may shop between multiple lenders, they may not be able to compare final loan terms between lenders due to the difficulties in applying for multiple loans. Conventionally, loan terms and rates may not be finalized until underwriting is complete and lenders cannot commit to specific loan terms until they assess the credit and financial strength of an applicant. Loan applications may require extensive documentation from a loan applicant, including income information, asset information, and bank account information. The extensive documentation that is required by each lender (which may differ between lenders) may make it very difficult for a loan applicant to provide this documentation to multiple lenders.

Additionally, mortgage loan lenders run credit reports for each loan applicant. Running these credit reports impacts an applicant's credit rating. Even after all information is collected, the information for each loan is processed individually, comparing the loan applicant's qualifications to underwriting criteria according to specific lender practices. Such mortgage loan underwriting criteria and even terminology used may vary significantly between different lenders. Applicants also often may have difficulty in shopping around for mortgage loans because most purchase contracts require that loan applications be submitted within a short time-frame (e.g., three to five days) after signing the purchase contract. It may be difficult for an applicant to make more than one loan application within such a short time frame.

For these and other reasons, it is technically challenging to automate the process of submitting mortgage loan applications to multiple lenders without damaging the credit of the applicant, placing other significant burdens on the applicant, and/or diminishing the ability of lenders to make sound decisions.

### SUMMARY OF THE INVENTION

The systems and methods described herein describe a comprehensive blockchain-based tool to address these and other issues. According to one aspect of the invention, the systems and methods described herein relate to a computer-implemented system configured to process applicant information and administer a mortgage via one or more blockchain-based smart contracts. A smart contract may include computer code configured to implement rules that control the loan origination process, the recordation of information and documentation on a blockchain, the administration of the loan itself, the generation and allocation of the cryptographic tokens, and/or one of more other features described herein.

One aspect of the invention described provides a system configured to facilitate the loan origination process for an applicant with minimal interaction with the lenders themselves. Loan origination is the process by which a borrower applies for a new loan, and a lender processes that application. Origination generally includes all the steps from taking a loan application up to disbursal of funds (or declining the application).

In order to facilitate the loan origination process, the system may generate and maintain a financial profile of an applicant. In various implementations, the system may electronically obtain and cryptographically record user information for an applicant on the blockchain. The user information may be encrypted and associated with a public key and a private key. In various implementations, the system may electronically obtain a credit report for the applicant. A credit report may be obtained for an applicant from each of multiple credit agencies or from a single credit agency. Based on the user information and the credit report, a financial profile of the applicant may be generated. In various implementations, the financial profile of an applicant may be maintained by monitoring or periodically obtaining user information and/or a credit report for the applicant and updating the financial profile accordingly. By maintaining an updated financial profile of each applicant and recording the updated financial profile for each applicant on a blockchain, an immutable record of each applicant's financial profile (and their financial history) may be maintained. In various implementations, the financial profile of an applicant (and the applicant information contained therein) may be processed to determine whether an applicant qualifies for a mortgage from each of a set of lenders.

In various implementations, loan qualification criteria may be received from each of the set of lenders. Loan qualification criteria may include criteria for determining whether or not an applicant qualifies for a loan from a lender, whether the lender will underwrite a loan for the applicant, and what types of loan terms are available to the applicant from the lender. The loan qualification criteria may differ from each lender to lender. Loan qualification criteria that is received may be stored in a lender database and recorded on a blockchain. Based on the loan qualification criteria received from each of the set of lenders, a set of information that is required to determine whether an applicant qualifies for a loan from each of the set of lenders may be identified. For example, the loan qualification criteria for each of a set of lenders may be identified and compared to determine the set of information that is needed from an applicant to assess the loan qualification criteria for the entire set of lenders. In various implementations, the system may determine whether the financial profile of an applicant includes the set of information required to determine whether the applicant qualifies for a loan from each of the set of lenders. For example, the financial profile may be reviewed to determine that each of the required pieces of information are contained therein. In some implementations, the financial profile and the information contained therein may be mapped to the set of information required to determine whether the applicant qualifies for a loan from each of the set of lenders.

In various implementations, the system may determine whether an applicant qualifies for a loan from each lender of the set of lenders based on the set of information included in the financial profile. For example, it may be determined that the applicant qualifies for a loan from a first lender of the set of lenders, but not a second lender, based on the set of information included in the financial profile of the applicant. Without further input from the lenders themselves, a qualification response may be provided to the applicant indicating each lender from which the applicant may qualify for a loan. The qualification response may include an indication of financial terms of the loan from the lender.

Once the system determines that an applicant may qualify for a loan from a lender, the system may determine whether information and/or documentation has been provided necessary for the loan to be approved. In some implementations, the system may determine whether the loan has been approved without additional input from the lender. For example, one or more smart contracts may program the computer system to control the approval process using one or more rules that factor in the approval requirements for each individual lender. In various implementations, the system may determine whether one or more conditions of the loan have been satisfied and cause the mortgage to be funded (e.g., via an escrow account) based on a determination that the one or more conditions have been satisfied.

In various implementations, the system may administer the mortgage itself. For example, in some implementations, each loan may be governed by a smart contract in which terms, conditions, actionable events, rates, and/or other aspects of a loan are defined. In some implementations, responsive to a determination that a mortgage has been funded, the system may automatically generate lien documentation and cause the lien documentation to be filed at a recording office and recorded to the blockchain. In some implementations, the system may obtain an indication that the loan has been paid in-full. Responsive to an indication that the loan has been paid in-full, the system may automatically generate lien release documentation and cause the lien release documentation to be filed at the recording office and recorded to the blockchain.

In various implementations, the system may handle title transfer related to the administration of a loan. For example, the system may generate a token representing title to property and associate the token with a lender for a loan involving a real estate transaction when the loan is executed on the property. In some implementations, the system may register the token with a token registry system. The token may be represented by a blockchain public key and private key pair. In some implementations, the token may include functions that represent a set of rights related to the title to the property. Upon satisfaction of the loan itself (i.e., when the loan has been paid in-full), the system may cause the token to be transferred from the lender to the applicant and cause the record of the token in the token registry system to be updated to reflect the transfer of ownership from the lender to the applicant.

These and other objects, features, and characteristics of the system and/or method disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an example of a system configured to process applicant information and administer a mortgage via one or more blockchain-based smart contracts, in accordance with one or more implementations of the invention.

FIG. 2 illustrates an example of a method for generating a financial profile of an applicant based on user information recorded on a blockchain, in accordance with one or more implementations of the invention.

FIG. 3 illustrates an example of a method for processing applicant information and administering a mortgage via one or more blockchain-based smart contracts, in accordance with one or more implementations of the invention.

### DETAILED DESCRIPTION OF THE INVENTION

It will be appreciated by those having skill in the art that the implementations described herein may be practiced without these specific details or with an equivalent arrangement. In other instances, well-known structures and devices are shown in block diagram form in order to avoid unnecessarily obscuring the implementations of the invention.

Overview of System Architecture

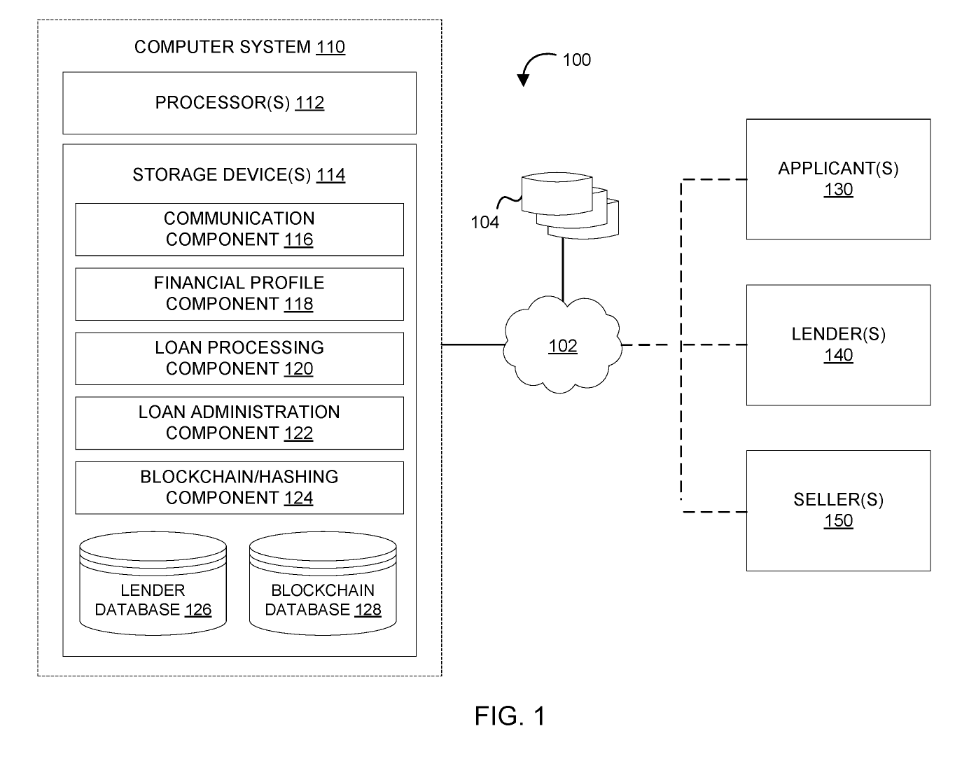

FIG. 1 illustrates a system 100 configured to process applicant information and administer a mortgage via one or more blockchain-based smart contracts, in accordance with one or more implementations of the invention. System 100 may include one or more databases 104, a computer system 110, and/or other components. As illustrated in FIG. 1, computer system 110 may communicate with or otherwise exchange information with one or more applicants 130, one or more lenders 140, one or more sellers 150, and/or one or more additional third parties via a network 102.

Computer system 110 may be configured as a server (e.g., having one or more server blades, processors, etc.), a gaming console, a handheld gaming device, a personal computer (e.g., a desktop computer, a laptop computer, etc.), a smartphone, a tablet computing device, and/or other device that can be programmed to process applicant information and administer a mortgage via one or more blockchain-based smart contracts, in accordance with one or more implementations of the invention. Computer system 110 may further be configured as a cloud based system.

Computer system 110 may include one or more physical processors 112 (also interchangeably referred to herein as one or more processors 112, processors 112, processor(s) 112, or processor 112 for convenience), one or more storage devices 114, and/or other components. Processor(s) 112 may be programmed by one or more computer program instructions. For example, processor(s) 112 may be programmed by communication component 116, financial profile component 118, loan processing component 120, loan administration component 122, blockchain/hashing component 124, and/or other instructions that program computer system 110 to perform various operations, each of which are described in greater detail herein. As used herein, for convenience, the various instructions will be described as performing an operation, when, in fact, the various instructions program the one or more processors 112 (and therefore computer system 110) to perform the operation. In some implementations, computer system 110 may include a lender database 126 and/or a blockchain database 128.

Processor(s) 112 may be configured to provide information processing capabilities in system 100. As such, processor(s) 112 may comprise one or more of a digital processor, an analog processor, a digital circuit designed to process information, a central processing unit, a graphics processing unit, a microcontroller, an analog circuit designed to process information, a state machine, and/or other mechanisms for electronically processing information.

Operating as a cloud-based system, one or more processors 112 of computer system 110 may be included in a plurality of server platforms and may cooperate to perform the functions that implement and/or instantiate computer system 110. Similarly, one or more storage devices of computer system 110 (e.g., one or more databases 104) may be distributed across multiple physical platforms, and cooperate to provide the required storage space. Computer system 110 may therefore operate as a virtualized system.

In various implementations, various features described herein as being performed by communication component 116, financial profile component 118, loan processing component 120, loan administration component 122, and/or blockchain/hashing component 124 may performed via one or more blockchain-based smart contracts. Smart contracts can be thought of as computerized transaction protocols that execute terms of a contract. Smart contracts are essentially self-executing contracts with the terms of the agreement between buyer and seller being directly written into and executed by lines of code. The code and the agreements contained therein can exist across a distributed, decentralized blockchain network. Using a scripting language or other techniques, a smart contract can include logic-based programs run on top of a blockchain. One or more of the features described herein may be executed based on blockchain-based smart contracts stored in a smart contract repository.

Communication component 116 may be configured to communicate with one or more applicants 130, one or more lenders 140, one or more sellers 150, and/or one or more additional third parties via a network 102. In various implementations, communication component 116 may be configured to communicate with one or more applicants 130 to receive user information, provide a qualification response indicating that that an applicant may qualify for a loan from one or more lenders 140, or otherwise communicate with one or more applicants 130 as described herein. For example, communication component 116 may be configured to provide a questionnaire to an applicant (i.e., one or more applicants 130) requesting user information to be included in a financial profile of the applicant.

In various implementations, communication component 116 may be configured to communicate with one or more lenders 140 to obtain lender information or otherwise communicate with one or more lenders 140 as described herein. Lender information for a specific lender may include general lender information (e.g., identification information, contact information, and/or other general lender information), loan qualification criteria (or underwriting criteria) for one or more loan products offered by the lender, pre-approval conditions for one or more loan products offered by the lender, conditions and/or financial terms for one or more loan products offered by the lender, and/or other information related to the lender. In some implementations, communication component 116 may be configured to communicate with one or more lenders 140 to obtain user information for an applicant known to one or more lenders 140. For example, accounts, existing loans, and/or other financial information for an applicant may be known to one or more lenders 140.

In some implementations, communication component 116 may be configured to communicate with one or more sellers 150 to provide requested and/or required documentation, request documentation and/or information related to a transaction, request user information known to one or more sellers 150 used to generate and/or update a financial profile of one or more applicants, and/or otherwise communicate with one or more sellers 150 during the loan origination and/or loan administration process. For example, communication component 116 may be configured to transmit an indication to seller 150 when a mortgage has funded for a real estate transaction involving seller 150.

In some implementations, communication component 116 may be configured to communicate with one or more third parties as necessary to gather and process applicant information and administer a mortgage via one or more blockchain-based smart contracts. For example, communication component 116 may be configured to communicate with one or more credit reporting agencies to obtain credit information of one or more applicants 130. In various implementations, communication component 116 may be configured to communicate with one or more third parties to obtain user information for an applicant known to the one or more third parties. For example, communication component 116 may be configured to communicate with third party financial institutions to receive information about an applicant's finances; background check services and/or law enforcement databases to determine additional application information; IRS and other government databases to obtain tax return and income information; payroll services, such as ADP, to obtain income information; and/or other third parties to obtain other user information.

In some implementations, communication component 116 may be configured to request user information for an applicant, lender information, and/or other information from one or more lenders 140, one or more sellers 150, and/or one or more additional third parties via a third party application programming interface (API). In some implementations, communication component 116 may be configured to provide a standardized from to a third party (e.g., an appraiser) and may receive information from a third party in a standardized format. In some implementations, communication component 116 may be configured to request user information for an applicant, lender information, and/or other information from one or more lenders 140, one or more sellers 150, and/or one or more additional third parties by formatting requests for user information from the one or more lenders 140, one or more sellers 150, and/or one or more additional third parties. For example, communication component 116 may be configured to format individual requests for user information for an applicant, lender information, and/or other information for individual lenders 140, sellers 150, and/or additional third parties based on stored information indicating format preferences for each of the individual lenders 140, sellers 150, and/or additional third parties.

In some implementations, communication component 116 may be configured to verify user information obtained from an applicant. For example, communication component 116 may be configured to communicate with one or more third parties to obtain property appraisals. In some implementations, communication component 116 may be configured to communicate with one or more third parties to maintain up-to-date user information for an applicant. Accordingly, the requirement for an applicant to obtain and provide copies of documents obtainable via automated electronic means may be obviated.

In some implementations, communication component 116 may be configured to facilitate communication with one or more applicants 130 according to regulatory disclosure requirements. Communication component 116 may provide one or more applicants 130 with all necessary information and disclosures, may accept all acknowledgments associated therewith, and/or otherwise may automate any aspect of a regulatory and compliance process necessary in the loan origination and administration process.

In some implementations, communication component 116 may be configured to generate and provide an interface to one or more applicants 130, one or more lenders 140, one or more sellers 150, and/or one or more additional third parties via a network 102. The interface may be presented via a user display of a user device associated with one or more applicants 130, one or more lenders 140, one or more sellers 150, and/or one or more additional third parties. Communication component 116 may be configured to present via the interface any data, information, and/or documents described as being obtained, stored, utilized, manipulated, generated, and/or otherwise interacted with herein.

Financial profile component 118 may be configured to generate and maintain a financial profile for each of one or more applicants 130. A financial profile of an applicant (i.e., one or more applicants 130) may include at least user information and a credit score for the applicant. For example, the user information may include information about an applicant's income, assets, employment, personal information, property information, credit scores, background, and any other relevant information. In some implementations, a financial profile may include financial documents, bank statements, pay stubs, tax returns, leases, property statements, asset statements, brokerage statements, and any other document or user information appropriate for use in loan origination and/or administration. In some implementations, a financial profile may include an indication of intentions, plans, and/or goals (e.g., how long applicant 130 plans to keep the property in question, whether they plan to lease the property, and/or other intentions, plans, and/or goals of applicant 130). Applicant intentions, plans, and/or goals may be gathered, for example, via an on-line applicant questionnaire. In some implementations, a financial profile may include information about one or more borrowers. For example, the financial profile for applicant 130 may include information indicating one or more potential co-borrowers of applicant 130. Financial profile component 118 may be configured to cryptographically record some or all of the information and documentation included in the financial profile on a blockchain.

In various implementations, financial profile component 118 may be configured to electronically obtain user information for an applicant. In some implementations, financial profile component 118 may be configured to request user information directly from an applicant. For example, financial profile component 118 may be configured to cause a questionnaire to be provided to an applicant (i.e., one or more applicants 130) requesting user information to be included in a financial profile of the applicant. In some implementations, financial profile component 118 may be configured to cause communication component 116 to communicate with one or more applicants 130 to obtain user information for one or more applicants 130. For example, financial profile component 118 may be configured to cause communication component 116 to provide a questionnaire to an applicant (i.e., one or more applicants 130). In some implementations, financial profile component 118 may be configured to cause communication component 116 to request user information from one or more lenders 140 and/or one or more additional third parties via a network 102.

In various implementations, financial profile component 118 may be configured to electronically obtain a credit report for an applicant. In some implementations, financial profile component 118 may be configured to obtain a single credit report for an applicant 130 from each of multiple credit agencies. In some implementations, financial profile component 118 may be configured to obtain a single credit report for an applicant 130 from a single major credit bureau. For example, financial profile component 118 may be configured to obtain one credit report for an applicant 130 from one or more of Equifax, Experian, and Transunion. Financial profile component 118 may cause credit information for an applicant 130 to be obtained from any source of credit reporting. In some implementations, financial profile component 118 may be configured to cause communication component 116 to communicate with one or more credit reporting agencies to obtain credit information of one or more applicants 130.

In situations involving multiple co-borrowers, credit reports may be obtained for each potential borrower. For example, in a situation involving two co-borrowers, six total credit reports, one for each borrower from each of three major credit agencies may be obtained. Financial profile component 118 may be configured to obtain no more than one credit report from a credit agency within a credit validity period. A credit validity period may be a period of time for which an obtained credit report may still be used during loan underwriting. Conventionally, credit validity periods may be 90 days, but other lengths of time may be applicable. At the end of a credit validity period, a credit report may expire and a new credit report may be required. As such, financial profile component 118 may be configured to electronically obtain an updated credit report for an applicant (i.e., one or more applicants 130). By obtaining no more than one credit report from a credit agency within a credit validity period, financial profile component 118 may minimize an impact on a loan applicant's credit score.

In various implementations, financial profile component 118 may be configured to generate a financial profile of applicant 130. Financial profile component 118 may be configured to generate a financial profile of applicant 130 based at least on user information and a credit report for applicant 130. In various implementations, financial profile component 118 may be configured to maintain the financial profile of an applicant (i.e., one or more applicants 130). For example, financial profile component 118 may be configured to cause a financial profile of an applicant (i.e., one or more applicants 130) to be updated based on new user information obtained related to the applicant and/or an updated credit report for the applicant. In some implementations, financial profile component 118 may be configured to cause the updated financial profile of an applicant to be recorded on the blockchain. For example, financial profile component 118 may be configured to cause blockchain/hashing component 124 to record an updated financial profile of an applicant on the blockchain. By maintaining an updated financial profile of each applicant and recording each updated financial profile for each applicant on a blockchain, an immutable record of each applicant's financial profile (and their financial history) may be maintained.

In some implementations, financial profile component 118 may be configured to standardize and/or normalize user information for applicants 130. Financial profiles for each of one or more applicants 130 may be standardized, wherein each financial profile includes one or more corresponding data fields storing the same data in the same format. In some implementations, each of the financial profiles for multiple applicants 130 may be completely standardized, including identical data fields storing data in identical formats. In some implementations, variations between financial profiles may be permitted—for example to store additional relevant information that may not necessarily fit among a set of standardized data fields.

In various implementations, financial profile component 118 may be configured to cause user information and/or a financial profile for each applicant to be stored in one or more databases 104. For example, financial profile component 118 may be configured to cause user information and/or a financial profile for each applicant to be stored in an applicant database. In various implementations, financial profile component 118 may be configured to cause user information and/or a financial profile for each applicant to be recorded on a blockchain. For example, financial profile component 118 may be configured to cause blockchain/hashing component 124 to record user information and/or a financial profile for each applicant on a blockchain. Recording user information and/or a financial profile for each applicant on a blockchain may comprise cryptographically recording the user information and/or financial profile on the blockchain. The user information and/or financial profile may be encrypted and associated with both a public key and a private key. The private key may only be provided to the applicant to which the financial profile relates.

In various implementations, financial profile component 118 may be configured to facilitate access to the financial profile of the applicant by multiple lenders 140. For example, financial profile component 118 may be configured to provide each of a set of lenders 140 with a public key via which each of the set of lenders 140 are able to access the financial profile of an applicant. In various implementations, financial profile component 118 may be configured to facilitate access to the financial profile of an applicant such that the credit score of the applicant is unaffected by the financial profile being accessed.

Loan processing component 120 may be configured to process applicant information in order to electronically facilitate a loan origination process. Loan origination is the process by which a borrower applies for a new loan, and a lender processes that application. Origination generally includes all the steps from taking a loan application up to disbursal of funds (or declining the application).

In various implementations, loan processing component 120 may be configured to obtain loan qualification criteria from a set of lenders 140. For example, loan processing component 120 may be configured to cause loan qualification criteria to be requested from a set of lenders 140. Loan qualification criteria (or underwriting criteria) may include employment criteria, financial asset criteria, credit score criteria, and/or other loan qualification criteria. In some implementations, additional information and qualifications (e.g., pre-approval conditions) may be obtained along with loan qualification criteria and stored in associated with the loan qualification criteria in lender database 126 and recorded on the blockchain.

Loan qualification criteria may including criteria for determining whether or not an applicant qualifies for a loan from a lender, whether the lender will underwrite a loan for the applicant, and what types of loan terms are available to the applicant from the lender. The loan qualification criteria may differ from each lender to lender. For example, loan processing component 120 may be configured to obtain first loan qualification criteria for a loan from a first lender and second loan qualification criteria for a loan from a second lender. The first loan qualification criteria may differ from the second loan qualification criteria.

In various implementations, loan processing component 120 may be configured to cause loan qualification criteria to be stored in one or more databases 104. For example, loan processing component 120 may be configured to cause loan qualification criteria to be stored in lender database 126. In various implementations, loan processing component 120 may be configured to cause loan qualification criteria to be recorded on a blockchain. For example, loan processing component 120 may be configured to cause blockchain/hashing component 124 to record loan qualification criteria on a blockchain. Recording loan qualification criteria on a blockchain may comprise cryptographically recording the loan qualification criteria on the blockchain. The loan qualification criteria may be encrypted and associated with both a public key and a private key. The private key may only be provided to the lender to which the loan qualification criteria relates.

In various implementations, loan processing component 120 may be configured to identify the set of information required to determine whether an applicant qualifies for a loan from each of the set of lenders 140. For example, loan processing component 120 may be configured to identify the loan qualification criteria for each of a set of lenders 140 and determine all the information that is needed to assess the loan qualification criteria for all of the set of lenders 140.

In an exemplary implementation, loan processing component 120 may be configured to obtain first loan qualification criteria, second loan qualification criteria, and third qualification criteria for loans from a first lender, a second lender, and a third lender, respectively. The first loan qualification criteria may comprise financial asset criteria and credit score criteria, so determining whether an applicant satisfies the first loan qualification criteria may require user information indicating an applicant's employment and credit score. The second loan qualification criteria may comprise financial asset criteria and credit score criteria, so determining whether an applicant satisfies the second loan qualification criteria may require user information indicating an applicant's financial assets and credit score. The third loan qualification criteria may comprise only credit score criteria, so determining whether an applicant satisfies the third loan qualification criteria may require only user information indicating an applicant's credit score. However, to identify the set of information required to determine whether an applicant qualifies for a loan from each of a set of lenders 140, each of the qualification criteria must be considered. In the foregoing exemplary implementation, the set of information required to determine whether an applicant qualifies for a loan from the first lender, the second lender, and the third lender would include user information indicating an applicant's employment (due to the first lender), financial assets (due to the second lender), and credit score (due to the first lender, the second lender, and the third lender).

In various implementations, loan processing component 120 may be configured to normalize loan qualification criteria obtained for a set of lenders 140. The loan qualification criteria may be obtained directly from the lenders 140. Each of the set of lenders 140 may utilize different terminology and/or methodology for assessing whether an applicant qualifies for a loan from that specific lender. Loan processing component 120 may be configured to normalize these differences in terminology and/or methodology. For example, loan processing component 120 may be configured to standardize the terminology and/or methodology for individual lenders based on standard terminology and/or methodology to generate normalized loan qualification criteria for each of the one or more lenders 140. The normalized loan qualification criteria for east of the set of lenders may be stored in lender database 126 and/or recorded on the blockchain in addition to and/or in replace of the loan qualification criteria received from that particular lender. In some implementations, loan processing component 120 may be configured to identify the set of information required to determine whether an applicant qualifies for a loan from each of the set of lenders 140 based on the normalized loan qualification criteria for each of the set of lenders 140.

In some implementations, loan processing component 120 may be configured to construct one or more loan product profiles from information obtained from a set of lenders 140, normalize loan qualification criteria and/or other information or documents, generate loan-specific parameters for an underwriting rule-set for inclusion with a normalized loan product profile, and/or otherwise automate the submission of mortgage loan applications to multiple lenders as described in co-pending U.S. patent application Ser. No. 15/357,481, entitled “APPLICANT INFORMATION PROCESSING TOOL,” Attorney Docket No. 53WA-248578, the disclosure of which is hereby incorporated by reference in its entirety herein.

In various implementations, loan processing component 120 may be configured to determine whether the financial profile of an applicant includes the set of information required to determine whether the applicant qualifies for a loan from each of the set of lenders 140. In some implementations, loan processing component 120 may be configured to map information included in a financial profile of an applicant 130 to each of the set of information required to determine whether the applicant qualifies for a loan from each of the set of lenders 140. In other words, if three pieces of information are required to determine whether an applicant qualifies for a loan from each of a set of lenders 140, loan processing component 120 may be configured to identify those three pieces of information within a financial profile of the applicant 130 and input that information as the required three pieces of information. For example, loan processing component 120 may be configured to map financial asset information to one or more required pieces of financial asset information, employment information to required employment information based on the scope of employment information required, and the credit score of an applicant 130 to the requirement for inclusion of a credit score.

In various implementations, loan processing component 120 may be configured to generate a digital mortgage application for an applicant based on the financial profile of the applicant. For example, loan processing component 120 may be configured to obtain the set of information required to determine whether an applicant qualifies for a loan from each of a set of lenders 140 from the financial profile of applicant 130 and generate a single digital mortgage application including all the information required by set of lenders 140. The single digital mortgage application may only contain required information. For example, the single digital mortgage application may include an applicant's income, credit score, assets, employment, personal information, property information, and/or other information as is required by the set of information required to determine whether the applicant qualifies for a loan from each of the set of lenders 140.

In various implementations, loan processing component 120 may be configured to determine whether an applicant qualifies for a loan from each of the set of lenders. For example, loan processing component 120 may be configured to determine that an applicant qualifies for a loan from a first lender of a set of lenders, but not a second lender of the set of lenders, based on the set of information included in the financial profile of the applicant. Loan processing component 120 may be configured to determine that an applicant qualifies for a loan from a first lender of a set of lenders based on loan qualification criteria provided by the first lender without further information or input from the first lender. In other words, loan processing component 120 may be configured to automatically determine whether an applicant qualifies for a loan from each of the set of lenders.

In various implementations, loan processing component 120 may be configured to cause a qualification response to be provided to an applicant indicating that the applicant may qualify for a loan from a lender responsive to a determination that the applicant qualifies for a loan from the lender. In some implementations, loan processing component 120 may be configured to generate a qualification response to be provided to an applicant indicating that the applicant may qualify for a loan from a lender. The qualification response may include an indication of financial terms of the loan from the lender. For example, a qualification response may comprise a document to be provided to one or more applicants 130 and/or one or more lenders 140. In some implementations, a single qualification response may be provided to an applicant 130 indicating each of the loans from one or more lenders for which applicant 130 qualifies. In some implementations, an individual qualification response may be provided to an applicant 130 for each loan and for each individual lender from which applicant 130 qualifies for a loan. In some implementations, loan processing component 120 may be configured to cause communication component 116 to communicate the qualification response to the applicant 130 responsive to a determination that the applicant qualifies for a loan from the lender. Loan processing component 120 may be configured to cause a qualification response to be provided to an applicant indicating that the applicant may qualify for a loan from a lender without further information or input from the lender. In other words, loan processing component 120 may be configured to automatically cause a qualification response to be provided to an applicant indicating that the applicant may qualify for a loan from a lender.

In various implementations, loan processing component 120 may be configured to cause a qualification response to be provided to the lender 140 indicating that the applicant may qualify for a loan from lender 140 responsive to a determination that the applicant qualifies for a loan from the lender. Loan processing component 120 may be configured to cause a qualification response to be provided to lender 140 indicating that the applicant may receive a loan from a lender without further information or input from the lender. In other words, loan processing component 120 may be configured to automatically cause a qualification response to be provided to lender 140 indicating that the applicant may qualify for a loan from the lender.

In various implementations, loan processing component 120 may be configured to obtain an indication of pre-approval conditions for a loan. For example, loan processing component 120 may be configured to cause pre-approval conditions to be requested from one or more lenders 140. Pre-approval conditions may include require demonstrating possession of certain documentation, possession of adequate collateral, and/or one or more other conditions that must be established before an applicant 130 can be approved for a loan from a lender.

In various implementations, loan processing component 120 may be configured to determine whether pre-approval conditions of a loan have been satisfied. In some implementations, loan processing component 120 may be configured to cause an indication that the financial terms of a loan are guaranteed for at least a predefined time period to be provided to an applicant 130 responsive to a determination that pre-approval conditions for the loan have been satisfied. Loan processing component 120 may be configured to cause an indication that the financial terms of a loan are guaranteed for at least a predefined time period to be provided to an applicant 130 without further information or input from the lender. In other words, loan processing component 120 may be configured to automatically cause an indication that the financial terms of a loan are guaranteed for at least a predefined time period to be provided to an applicant 130.

In various implementations, loan processing component 120 may be configured to facilitate approval of a selected loan for which applicant 130 qualifies. In some implementations, loan processing component 120 may be configured to receive an indication of a selected loan from one of the set of lenders for which the user qualifies. Responsive to the indication of the selection of a loan from a first lender, loan processing component 120 may be configured to automatically provide to the applicant documentation required to validate information needed to finalize approval of the applicant for the loan from the first lender. In various implementations, one or more smart contracts may program computer system 110 to automatically provide applicant 130 with the documentation required responsive to the indication of the selection of the loan. The documentation may be required to validate information (e.g., salary, financial assets, employment, credit score, digital title records, and/or other information) from one or more applicants 130, one or more lenders 140, one or more sellers 150, and/or one or more additional third parties.

Loan administration component 122 may be configured to administer a selected loan. For example, the selected loan may comprise a loan for which the loan origination process was executed or facilitated by loan processing component 120. In various implementations, the features performed by loan administration component 122 described herein may be executed based on one or more blockchain-based smart contracts. Each loan may be associated with a single blockchain-based smart contract (stored in a smart contract repository) configured to govern the administration of the loan.

In various implementations, loan administration component 122 may be configured to determine that one or more conditions of a loan have been satisfied. Responsive to the determination that the one or more loan conditions have been satisfied, one or more smart contracts may program computer system 110 to cause the mortgage to fund. In some implementations, loan administration component 122 may be configured to create an escrow account associated with the loan. To cause the mortgage to fund, loan administration component 122 may be configured to cause a deposit to be made to the escrow account. In some implementations, one or more smart contracts may program computer system 110 to cause a deposit to be made to the escrow account and/or obtain an indication that a deposit has been made to the escrow account. In various implementations, loan administration component 122 may be configured to cause the transaction crediting the escrow account to be recorded to the blockchain via blockchain/hashing component 124.

In an exemplary implementation in which the loan is related to a real estate transaction involving applicant 130 and seller 150, loan administration component 122 may be configured to receive documentation indicating that the real estate transaction has closed. Responsive to the receipt of the documentation indicating that the real estate transaction has closed, loan administration component 122 may be configured to automatically transfer all or a portion of the balance of the escrow account to an account of the seller. In some implementations, one or more smart contracts associated with a loan may program computer system 110 to automatically transfer all or a portion of the balance of the escrow account to an account of the seller responsive to the receipt of the documentation indicating that the real estate transaction has closed.

In various implementations, loan administration component 122 may be configured to determine that a mortgage has been funded. Responsive to a determination that a mortgage has been funded, one or more smart contracts may program computer system 110 to automatically generate lien documentation. The one or more smart contracts may program computer system 110 to cause the lien documentation to be filed at a recording office and recorded on a blockchain.

In various implementations, loan administration component 122 may be configured to obtain an indication that the loan has been paid in-full. Responsive to an indication that the loan has been paid in-full, one or more smart contracts may program computer system 110 to automatically generate lien release documentation. The one or more smart contracts may program computer system 110 to cause the lien release documentation to be filed at the recording office and recorded to the blockchain.

In various implementations, loan processing component 120 may be configured to transfer title to property in response to an indication that the loan has been paid in full. In some implementations, loan processing component 120 may be configured to generate a token representing title to property. In some implementations, loan processing component 120 may be configured to generate a token representing title to property and associate the token with lender 140 when a loan involving applicant 130 and lender 140 is executed on the property. In some implementations, loan processing component 120 may be configured to cause the token to be registered with a token registry system. The token may be represented by a blockchain public key and private key pair. The token may have a specified set of functions and/or parameters, which can be programmed in a known manner. As one example, the token may comply with the ERC-20 standard. The ERC-20 standard is a common set of rules for tokens issued via Ethereum smart contracts. In some implementations, the token may include functions that represent a set of rights related to the title to the property. For example, unencumbered blockchain-based tokens may be transferable by the holder of the token. Upon satisfaction of the loan itself (i.e., that the loan has been paid in-full), loan processing component 120 may be configured to cause the token to be transferred from lender 140 to applicant 130. For example, loan processing component 120 may be configured to cause the record of the token in the token registry system to be updated to reflect the transfer of ownership from lender 140 to applicant 130, wherein the token is associated with applicant 130 instead of lender 140.

Blockchain/hashing component 124 may be configured to record information to the blockchain, as described above. In order to record information to the blockchain, blockchain/hashing component 124 may be configured to perform a secure hashing operation on a data block to create a hashed block. In various implementations, blockchain/hashing component 124 may be configured to record information to the blockchain in a manner known in the art. In various implementations, blockchain/hashing component 124 may be configured to cryptographically record on the blockchain all information and documentation related to each loan administered.

Many types of blockchains exist. In general, they are distributed ledgers shared by the nodes on a network to which transactions are recorded and validated. A block is a part of a blockchain, which records some or all of the recent transactions. Once completed, a block is stored in the blockchain as a permanent database. Each time a block gets completed, a new one is generated. Each block in the blockchain is connected to the others (like links in a chain) in proper linear, chronological order. Every block contains a hash of the previous block. The blockchain has information about different user addresses and their balances right from the genesis block to the most recently completed block. Blockchains can be public or private and permissioned or permission-less.

The recordation of information on a blockchain is typically implemented using public and private “keys,” which may be long strings of numbers and letters linked through the cryptographic algorithm that was used to create them. An address is derived from the public key and is comparable to a bank account number which is published to the world. The private key (comparable to an ATM PIN) is meant to be a guarded secret, and only used to authorize information private to the individual to which the private key is issued.

Lender database 126 may be configured to store information related to one or more lenders 140. For example, lender database 126 may be configured to store, in association with each lender of one or more lenders 140, lender information, loan qualification criteria, additional information and qualifications (e.g., pre-approval conditions), normalized loan qualification criteria, and/or other information or documentation obtained, generated, and/or utilized by computer system 110 related to one or more lenders 140. In some implementations, lender database 126 may be configured to store a lender profile for each lender of one or more lenders 140 indicating loan products offered by the lender and including all other information or documentation obtained, generated, and/or utilized by computer system 110 related to the lender. In some implementations, each lender profile may be publicly accessible via a public key and privately accessible by authorized users (e.g., users designated by the lender associated with the lender profile) via a private key.

Blockchain database 128 may be configured to store blockchain data. For example, blockchain database 128 may be configured to store a private ledger and/or a public ledger including blocks of user information (including a financial profile for one or more lenders 130) and other information and/or documentation generated, obtained, utilized, or otherwise interacted with during the loan origination and/or loan administration process. In various implementations, blockchain database 128 may be configured to store hashed blockchain data created by blockchain/hashing component 124. The hashed blockchain data created by blockchain/hashing component 124 may be stored in the blockchain database 128 in a manner known in the art.

In various implementations, blockchain database 128 may include a smart contract repository configured to store one or more blockchain-based smart contracts. A smart contract repository may be configured to store one or more smart contracts. For example, the smart contract repository of blockchain database 128 may be configured to store a smart contract associated with each loan executed between one or more applicants 130 and one or more lenders 140. Smart contracts stored in a smart contract repository may define terms, conditions, actionable events, rates, and/or other aspects of a loan involving one or more applicants 130 and one or more lenders 140 to which it is associated. Smart contracts stored in a smart contract repository may programmatically control the administration of the loan in accordance with the terms defined by the smart contract.

### Exemplary Flowcharts of Processes

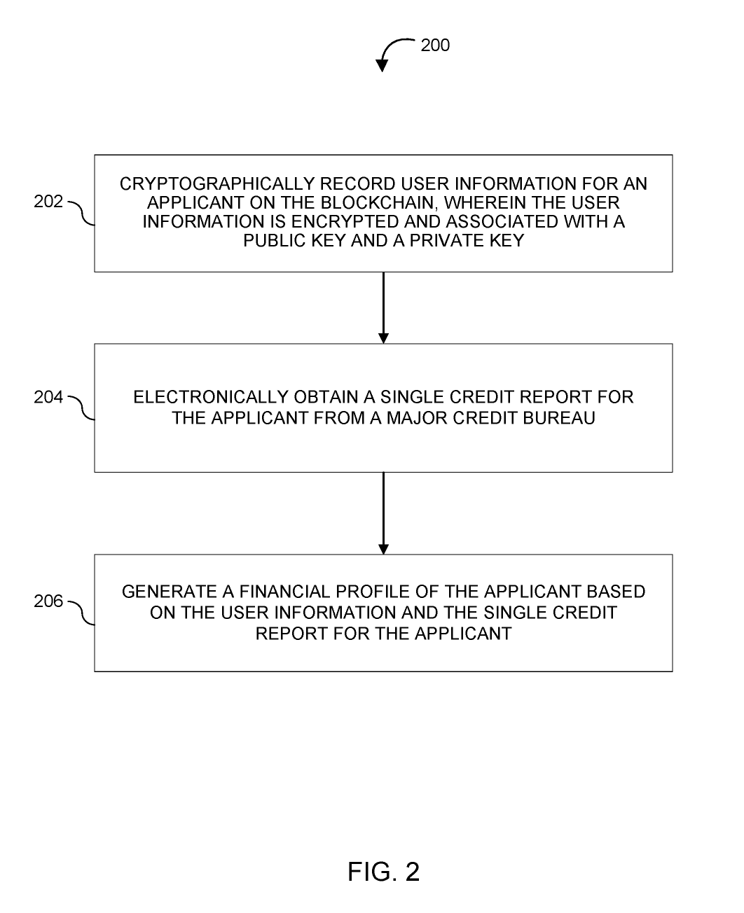

FIG. 2 illustrates a method 200 for generating a financial profile of an applicant based on user information recorded on a blockchain, in accordance with one or more implementations of the invention. The operations of process 200 presented below are intended to be illustrative and, as such, should not be viewed as limiting. In some implementations, process 200 may be accomplished with one or more additional operations not described, and/or without one or more of the operations discussed. In some implementations, two or more of the operations may occur substantially simultaneously. The described operations may be accomplished using some or all of the system components described in detail above.

In some implementations, process 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of process 200 in response to instructions stored electronically on one or more electronic storage mediums. The one or more processing devices may include one or more devices configured through hardware, firmware, and/or software to be specifically designed for execution of one or more of the operations of process 200.

In an operation 202, process 200 may include cryptographically recording user information for an applicant on the blockchain. The user information may be encrypted and associated with a public key and a private key. In some implementations, operation 202 may be performed by a processor component the same as or similar to financial profile component 118 and/or blockchain/hashing component 124 (shown in FIG. 1 and described herein).

In an operation 204, process 200 may include electronically obtaining a credit report for the applicant. For example, a single credit report may be obtained from a major credit bureau. In some implementations, a single credit report for an applicant may be obtained from each of multiple credit agencies. In some implementations, a single credit report for an applicant may be obtained from a single major credit bureau. For example, a credit report for an applicant may be obtained from one or each of Equifax, Experian, and Transunion. In some implementations, operation 204 may be performed by a processor component the same as or similar to communication component 116 and/or financial profile component 118 (shown in FIG. 1 and described herein).

In an operation 206, process 200 may include generating a financial profile of the applicant based on the user information and the credit report for the applicant. The financial profile may include at least a credit score for the applicant. In various implementations, the financial profile of an applicant may be maintained by monitoring or periodically obtaining user information and/or a credit report for the applicant and updating the financial profile accordingly. By maintaining an updated financial profile of each applicant and recording the updated financial profile for each applicant on a blockchain, an immutable record of each applicant's financial profile (and their financial history) may be maintained. In some implementations, operation 206 may be performed by a processor component the same as or similar to financial profile component 118 (shown in FIG. 1 and described herein).

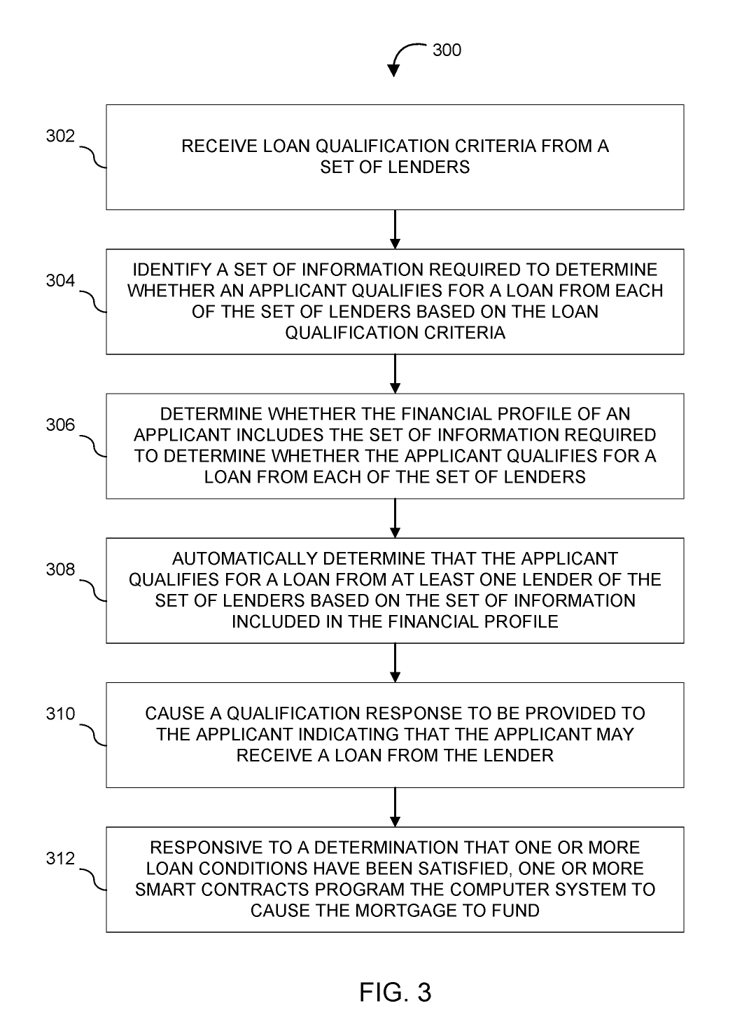

FIG. 3 illustrates a method 300 for processing applicant information and administering a mortgage via one or more blockchain-based smart contracts, in accordance with one or more implementations of the invention. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations may occur substantially simultaneously. The described operations may be accomplished using some or all of the system components described in detail above.

In some implementations, process 300 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of process 300 in response to instructions stored electronically on one or more electronic storage mediums. The one or more processing devices may include one or more devices configured through hardware, firmware, and/or software to be specifically designed for execution of one or more of the operations of process 300.

In an operation 302, process 300 may include receiving loan qualification criteria from a set of lenders. Loan qualification criteria (or underwriting criteria) may include employment criteria, financial asset criteria, credit score criteria, and/or other loan qualification criteria. Loan qualification criteria may including criteria for determining whether or not an applicant qualifies for a loan from a lender, whether the lender will underwrite a loan for the applicant, and what types of loan terms are available to the applicant from the lender. The loan qualification criteria may differ from each lender to lender. Loan qualification criteria that is received may be stored in a lender database and recorded on a blockchain. The loan qualification criteria may be encrypted and associated with both a public key and a private key. The private key may only be provided to the lender to which the loan qualification criteria relates. In some implementations, operation 302 may be performed by a processor component the same as or similar to communication component 116 and/or loan processing component 120 (shown in FIG. 1 and described herein).

In an operation 304, process 300 may include identifying a set of information required to determine whether an applicant qualifies for a loan from each of the set of lenders based on the loan qualification criteria. For example, the loan qualification criteria for each of a set of lenders may be identified and compared to determine the set of information that is needed from an applicant to assess the loan qualification criteria for the entire set of lenders. In some implementations, operation 304 may be performed by a processor component the same as or similar to loan processing component 120 (shown in FIG. 1 and described herein).

In an operation 306, process 300 may include determining whether the financial profile of an applicant includes the set of information required to determine whether the applicant qualifies for a loan from each of the set of lenders. For example, the set of information may comprise three pieces of information—financial asset information, employment information, and a credit score. The financial profile may be reviewed to determine that each of the three required pieces of information are contained therein. In some implementations, the financial profile and the information contained therein may be mapped to the set of information required to determine whether the applicant qualifies for a loan from each of the set of lenders. For example, financial asset information may be mapped to one or more required pieces of financial asset information, employment information may be mapped to required employment information based on the scope of employment information required, and the credit score of the applicant may be mapped to the requirement for inclusion of a credit score. In some implementations, operation 306 may be performed by a processor component the same as or similar to loan processing component 120 (shown in FIG. 1 and described herein).

In an operation 308, process 300 may include determining that the applicant qualifies for a loan from at least one lender of the set of lenders based on the set of information included in the financial profile. For example, it may be determined that the applicant qualifies for a loan from a first lender of a set of lenders, but not a second lender of the set of lenders, based on the set of information included in the financial profile of the applicant. It may be determined that an applicant qualifies for a loan from a first lender of a set of lenders based on loan qualification criteria provided by the first lender without further information or input from the first lender. In other words, it may be automatically determined whether an applicant qualifies for a loan from each of the set of lenders. In some implementations, operation 308 may be performed by a processor component the same as or similar to loan processing component 120 (shown in FIG. 1 and described herein).

In an operation 310, process 300 may include causing a qualification response to be provided to the applicant indicating that the applicant may qualify for a loan from the lender. The qualification response may include an indication of financial terms of the loan from the lender. For example, a qualification response may comprise a document to be provided to one or more applicants and/or one or more lenders. In some implementations, a single qualification response may be provided to an applicant indicating each of the loans from one or more lenders for which applicant qualifies. In some implementations, an individual qualification response may be provided to an applicant for each loan and for each individual lender from which applicant qualifies for a loan. A qualification response may be communicated to an applicant without further information or input from the lender. In other words, a qualification response may be automatically provided to an applicant based on a determination that the applicant qualifies for a loan. In various implementation, a qualification response may also be provided to a lender based on a determination that an applicant qualifies for a loan from that lender. In some implementations, operation 310 may be performed by a processor component the same as or similar to communication component 116 and/or loan processing component 120 (shown in FIG. 1 and described herein).

In an operation 312, process 300 may include causing the mortgage to fund responsive to a determination that one or more loan conditions have been satisfied. For example, one or more smart contracts may program the computer system to cause the mortgage to fund responsive to a determination that one or more loan conditions have been satisfied. In some implementations, operation 312 may be performed by a processor component the same as or similar to loan administration component 122 (shown in FIG. 1 and described herein).

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in one or more storage device(s) 114 which may comprise random access memory (RAM), read only memory (ROM), and/or other memory. The storage device may store the computer program instructions (e.g., the aforementioned instructions) to be executed by processor(s) 112 as well as data that may be manipulated by processor(s) 112. The storage device may comprise floppy disks, hard disks, optical disks, tapes, or other storage media for storing computer-executable instructions and/or data.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although illustrated in FIG. 1 as a single component, computer system 110 and user device(s) associated with one or more applicants 130, one or more lenders 140, one or more sellers 150, and/or one or more additional third parties may each include a plurality of individual components (e.g., computer devices) each programmed with at least some of the functions described herein. In this manner, some components of computer system 110 and/or associated user devices may perform some functions while other components may perform other functions, as would be appreciated.

Furthermore, it should be appreciated that although the various instructions are illustrated in FIG. 1 as being co-located within a single processing unit, in implementations in which processor(s) 112 include multiple processing units, one or more instructions may be executed remotely from the other instructions.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The one or more databases 104 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The one or more databases 104 can include any known suitable database and may comprise one or more such databases that reside in one or more physical devices and in one or more physical locations. The one or more databases 104 may store a plurality of types of data and/or files. In various implementations, one or more databases 104 may be configured to store any of the data, information, and/or documents described as being obtained, stored, utilized, manipulated, generated, and/or otherwise interacted with herein.

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A system configured to programmatically implement mortgage approval, processing, settlement, and recordation based on information recorded to a blockchain via one or more blockchain-based smart contracts, the system comprising:
a memory configured to store the one or more blockchain-based smart contracts, the one or more smart contracts comprising computer program instructions configured to implement rules that process the applicant information and administer the mortgage; and
a computer system comprising one or more physical processors programmed with computer program instructions that, when executed by the one or more physical processors, program the computer system to:
cryptographically record user information for an applicant on the blockchain, wherein the user information is encrypted and associated with a public key and a private key;
electronically obtain a single credit report for the applicant from a major credit bureau;
generate a financial profile of the applicant based at least on the user information and the single credit report for the applicant, wherein the financial profile includes a credit score of the applicant and is cryptographically recorded on the blockchain;
receive loan qualification criteria from a set of lenders;
identify a set of information required to determine whether the applicant qualifies for a loan from the set of lenders based on the loan qualification criteria, wherein the set of information comprises at least first criteria information, second criteria information, and third criteria information;
determine whether the financial profile of the applicant includes the set of information required to determine whether the applicant qualifies for a loan from the set of lenders;
automatically determine that the applicant qualifies for a loan from at least a first lender of the set of lenders based on the set of information included in the financial profile;
responsive to a determination that the applicant qualifies for a loan from at least the first lender, cause a qualification response to be provided to the applicant indicating that the applicant may qualify for a loan from the first lender with no further input from the first lender; and
determine that one or more conditions of the loan have been satisfied, wherein responsive to the determination that the one or more loan conditions have been satisfied, the one or more smart contracts program the computer system to cause the mortgage to fund.

2. The system of claim 1, wherein the computer system is further programmed to:
facilitate access to the financial profile of the applicant by multiple lenders, the multiple lenders including at least the first lender and a second lender, wherein accessing the financial profile of the applicant does not affect the credit score of the applicant.

3. The system of claim 1, wherein the computer system is further programmed to:
electronically obtain an updated credit report for the applicant from a major credit bureau;
cause the financial profile to be updated based on the updated credit report; and
cause the updated financial profile of the applicant to be recorded on the blockchain.

4. The system of claim 1, wherein the computer program is further programmed to:
generate a digital mortgage application for the applicant based on the financial profile of the applicant.

5. The system of claim 1, wherein the loan qualification criteria includes employment criteria, financial asset criteria, and/or credit score criteria.

6. The system of claim 1, wherein the loan qualification criteria from the set of lenders includes first loan qualification criteria for the loan from the first lender and second loan qualification criteria for a second loan from a second lender, wherein to identify the set of information required to determine whether the applicant qualifies for a loan from at least the first lender and the second lender, the computer system is further programmed to:
normalize the first loan qualification criteria and the second loan qualification criteria to generate first and second normalized loan qualification criteria, wherein the set of information is based on the first and second normalized loan qualification criteria.

7. The system of claim 1, wherein to determine whether the financial profile of the applicant includes the set of information required to determine whether the applicant qualifies for a loan from the set of lenders, the computer system is further programmed to:
map first user information of the financial profile to first criteria information of the set of information;
map second user information of the financial profile to second criteria information of the set of information; and
map third user information of the financial profile to third criteria information of the set of information.

8. The system of claim 1, wherein the qualification response provided to the applicant includes an indication of financial terms of the loan from the first lender, wherein the computer system is further programmed to:
obtain an indication of pre-approval conditions for the loan; and
determine that the pre-approval conditions have been satisfied, wherein responsive to the determination that the pre-approval conditions have been satisfied, the one or more smart contracts further program the computer system to cause an indication that the financial terms of the loan are guaranteed for at least a predefined time period to be provided automatically to the applicant and the first lender and recorded to the blockchain.

9. The system of claim 1, wherein the computer system is further programmed to:
receive an indication of a selection of a loan from one of the set of lenders for which the user qualifies, wherein the selected loan comprises the loan from the first lender;
wherein responsive to the indication of the selection of the loan from the first lender, the one or more smart contracts program the computer system to automatically provide to the applicant documentation required to validate information needed to finalize approval of the applicant for the loan from the first lender.

10. The system of claim 1, wherein the computer system is further programmed to:
determine that the mortgage has been funded, wherein responsive to the determination that the mortgage has been funded, the one or more smart contracts program the computer system to automatically generate lien documentation and cause the lien documentation to be filed at a recording office and recorded to the blockchain.

11. The system of claim 1, wherein to cause the mortgage to fund, the one or more smart contracts further program the computer system to:
create an escrow account associated with the loan; and
obtain an indication that the escrow account associated with the loan has been credited, wherein an indication of the transaction crediting the escrow account is recorded to the blockchain.

12. The system of claim 11, wherein the loan is related to a real estate transaction involving the applicant and a seller, wherein the computer system is further programmed to:
receive documentation indicating that the real estate transaction has closed, wherein responsive to the receipt of the documentation indicating that the real estate transaction has closed, the one or more smart contracts further program the computer system to automatically transfer all or a portion of the balance of the escrow account to an account of the seller.

13. The system of claim 1, wherein the computer system is further programmed to:
obtain an indication that the loan has been paid in-full, wherein responsive to the indication that the loan has been paid in-full, the one or more smart contracts further program the computer system to automatically generate lien release documentation and cause the lien release documentation to be filed at the recording office and recorded to the blockchain.

14. The system of claim 13, wherein the loan is related to the sale of real property, and wherein the computer system is further programmed to:
generate a token representing title in the real property;
cause the token to be registered in a token registry system in association with the first lender responsive to the determination that the one or more conditions of the loan have been satisfied; and
responsive to receipt of an indication that the loan has been paid in-full, cause the token to be transferred from the first lender to the applicant, wherein transferring the token from the first lender to the applicant comprises at least causing the token to be registered in the token registry system in association with the applicant.

15. The system of claim 1, wherein the computer system is further programmed to:
cryptographically record all information and documentation related to the loan from the first lender on the blockchain.

16. A method of programmatically implementing mortgage approval, processing, settlement, and recordation based on information recorded to a blockchain via one or more blockchain-based smart contracts, the method being implemented in a computer system having one or more physical processors programmed with computer program instructions that, when executed by the one or more physical processors, program the computer system to perform the method, the method comprising:
cryptographically recording, by the computer system, user information for an applicant on the blockchain, wherein the user information is encrypted and associated with a public key and a private key;
electronically obtaining, by the computer system, a single credit report for the applicant from a major credit bureau;
generating, by the computer system, a financial profile of the applicant based at least on the user information and the single credit report for the applicant, wherein the financial profile includes a credit score of the applicant and is cryptographically recorded on the blockchain;
receiving, by the computer system, loan qualification criteria from a set of lenders;
identifying, by the computer system, a set of information required to determine whether the applicant qualifies for a loan from the set of lenders based on the loan qualification criteria, wherein the set of information comprises at least first criteria information, second criteria information, and third criteria information;
determining, by the computer system, whether the financial profile of the applicant includes the set of information required to determine whether the applicant qualifies for a loan from the set of lenders;
automatically determining, by the computer system, that the applicant qualifies for a loan from at least a first lender of the set of lenders based on the set of information included in the financial profile;
electronically accessing, by the computer system, a memory configured to store the one or more blockchain-based smart contracts, the one or more smart contracts comprising computer program instructions configured to administer the mortgage, wherein administering the mortgage comprises:
causing, by the computer system, a qualification response to be provided to the applicant indicating that the applicant may qualify for a loan from the first lender with no further input from the first lender responsive to a determination that the applicant qualifies for a loan from at least the first lender;
determining, by the computer system, that one or more conditions of the loan have been satisfied; and
responsive to the determination that the one or more loan conditions have been satisfied, causing, by the computer system, the mortgage to fund.

17. The method of claim 16, the method further comprising:
facilitating, by the computer system, access to the financial profile of the applicant by multiple lenders, the multiple lenders including at least the first lender and a second lender, wherein accessing the financial profile of the applicant does not affect the credit score of the applicant.

18. The method of claim 16, the method further comprising:
electronically obtaining, by the computer system, an updated credit report for the applicant from a major credit bureau;
causing, by the computer system, the financial profile to be updated based on the updated credit report; and
causing, by the computer system, the updated financial profile of the applicant to be recorded on the blockchain.

19. The method of claim 16, the method further comprising:
generating, by the computer system, a digital mortgage application for the applicant based on the financial profile of the applicant.

20. The method of claim 16, wherein the loan qualification criteria includes employment criteria, financial asset criteria, and/or credit score criteria.

21. The method of claim 16, wherein the loan qualification criteria from the set of lenders includes first loan qualification criteria for the loan from the first lender and second loan qualification criteria for a second loan from a second lender, wherein identifying the set of information required to determine whether the applicant qualifies for a loan from at least the first lender and the second lender comprises:
normalizing, by the computer system, the first loan qualification criteria and the second loan qualification criteria to generate first and second normalized loan qualification criteria, wherein the set of information is based on the first and second normalized loan qualification criteria.

22. The method of claim 16, wherein determining whether the financial profile of the applicant includes the set of information required to determine whether the applicant qualifies for a loan from the set of lenders comprises:
mapping, by the computer system, first user information of the financial profile to first criteria information of the set of information;
mapping, by the computer system, second user information of the financial profile to second criteria information of the set of information; and
mapping, by the computer system, third user information of the financial profile to third criteria information of the set of information.

23. The method of claim 16, wherein the qualification response provided to the applicant includes an indication of financial terms of the loan from the first lender, the method further comprising:
obtaining, by the computer system, an indication of pre-approval conditions for the loan; and
determining, by the computer system, that the pre-approval conditions have been satisfied; and
causing, by the computer system, an indication that the financial terms of the loan are guaranteed for at least a predefined time period to be provided automatically to the applicant and the first lender and recorded to the blockchain responsive to the determination that the pre-approval conditions have been satisfied.

24. The method of claim 16, the method further comprising:
receiving, by the computer system, an indication of a selection of a loan from one of the set of lenders for which the user qualifies, wherein the selected loan comprises the loan from the first lender; and
responsive to the indication of the selection of the loan from the first lender, automatically providing to the applicant, by the computer system, documentation required to validate information needed to finalize approval of the applicant for the loan from the first lender.

25. The method of claim 16, the method further comprising:
determining, by the computer system, that the mortgage has been funded;
responsive to the determination that the mortgage has been funded, automatically generating, by the computer system, lien documentation; and
causing, by the computer system, the lien documentation to be filed at a recording office and recorded to the blockchain.

26. The method of claim 16, wherein causing the mortgage to fund comprises:
creating, by the computer system, an escrow account associated with the loan; and
obtaining, by the computer system, an indication that the escrow account associated with the loan has been credited, wherein an indication of the transaction crediting the escrow account is recorded to the blockchain.

27. The method of claim 26, wherein the loan is related to a real estate transaction involving the applicant and a seller, the method further comprising:
receiving, by the computer system, documentation indicating that the real estate transaction has closed; and
responsive to the receipt of the documentation indicating that the real estate transaction has closed, automatically transferring, by the computer system, all or a portion of the balance of the escrow account to an account of the seller.

28. The method of claim 16, the method further comprising:
obtaining, by the computer system, an indication that the loan has been paid in-full;
responsive to the indication that the loan has been paid in-full, automatically generating, by the computer system, lien release documentation; and
causing, by the computer system, the lien release documentation to be filed at the recording office and recorded to the blockchain.

29. The method of claim 28, wherein the loan is related to the sale of real property, the method further comprising:
generating, by the computer system, a token representing title in the real property;
causing, by the computer system, the token to be registered in a token registry system in association with the first lender responsive to the determination that the one or more conditions of the loan have been satisfied; and
responsive to receipt of an indication that the loan has been paid in-full, causing, by the computer system, the token to be transferred from the first lender to the applicant, wherein transferring the token from the first lender to the applicant comprises at least causing the token to be registered in the token registry system in association with the applicant.

30. The method of claim 16, the method further comprising:
cryptographically recording, by the computer system, all information and documentation related to the loan from the first lender on the blockchain.
